(19) United States
(12) Patent Application Publication
(10) Pub. No.: US 2024/0430798 A1
(43) Pub. Date: Dec. 26, 2024

(54) SYSTEMS AND METHODS FOR INDICATING TARGET WAKE TIME SERVICE PERIOD TERMINATION

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/590,536

(22) Filed: Feb. 28, 2024

Related U.S. Application Data
(60) Provisional application No. 63/523,159, filed on Jun. 26, 2023.

(51) Int. Cl. H04W 52/02; H04W 72/23

(52) U.S. Cl. CPC H04W 52/0216; H04W 72/23

(57) ABSTRACT

Systems, methods, and devices for indicating a target wake time (TWT) service period (SP) termination may include a first device which receives, from a second device, an indication for terminating a TWT SP. The first device may determine a status of downlink traffic for transmission to the second device. The first device may transmit, to the second device, an SP termination notification according to the status of the downlink traffic and the indication. The first device may terminate the TWT SP according to the SP termination notification.

### CROSS-REFERENCE TO RELATED APPLICATIONS

This application claims the benefit of and priority to U.S. Provisional Application No. 63/523,159, filed Jun. 26, 2023, the contents of which are incorporated herein by reference in their entirety.

### FIELD OF DISCLOSURE

The present disclosure is generally related to communications, including but not limited systems and methods for indicating target wake time service period termination.

### BACKGROUND

Devices can enter low power states to reduce energy usage during times of inactivity. Battery operated devices may employ low power states to extend battery life, though lowering energy consumption of all devices can aid in improving efficiency of operation. For example, wireless communication devices can synchronize operational windows to reduce power usage, such as by establishing a target wake times (TWT) in a wireless fidelity (Wi-Fi) network.

Artificial reality, such as a virtual reality (VR), augmented reality (AR), or mixed reality (MR), provides immersive experience to a user. In one example, a head wearable display (HWD) can display an image of a virtual object generated by a computing device communicatively coupled to the HWD, such as over a wireless network. The network can include various peripheral or other devices.

### SUMMARY

In one aspect, this disclosure is directed to a method. The method may include receiving, by a first device from a second device, an indication for terminating a target wake time (TWT) service period (SP). The method may include determining, by the first device, a status of downlink traffic for transmission to the second device. The method may include transmitting, by the first device to the second device, an SP termination notification according to the status of the downlink traffic and the indication. The method may include terminating, by the first device, the TWT SP according to the SP termination notification.

In some embodiments, the first device includes an access point, and the second device includes a station. In some embodiments, determining the status of the downlink traffic includes determining, by the first device, an absence of any downlink traffic (e.g., remaining or additional downlink traffic) for transmission (e.g., to be transmitted) to the second device. The SP termination notification may be transmitted according to the absence. In some embodiments, determining the status of the downlink traffic includes determining, by the first device, a presence of the downlink traffic (e.g., remaining or additional downlink traffic) for transmission (e.g., to be transmitted) to the second device.

In some embodiments, the method includes transmitting, by the first device to the second device, the downlink traffic. The SP termination notification may be transmitted responsive to transmission of the downlink traffic. In some embodiments, the first device receives the indication as a defined value in a buffer status report (BSR) from the second device. In some embodiments, the defined value includes a predetermined value of a queue size of the BSR. In some embodiments, the defined value comprises a predetermined combination of values, corresponding to an access category (ACI) bitmap field and a delta traffic identifier (TID) field.

In another aspect, this disclosure is directed to a first device. The first device may include a transceiver and one or more processors configured to receive, via a transceiver from a second device, an indication for terminating a target wake time (TWT) service period (SP). The one or more processors may be configured to determine a status of downlink traffic for transmission to the second device. The one or more processors may be configured to transmit, to the second device, an SP termination notification according to the status of the downlink traffic and the indication. The one or more processors may be configured to terminate the TWT SP according to the SP termination notification.

In some embodiments, the first device comprises an access point and the second device comprises a station. In some embodiments, one or more processors are configured, to determine the status of the downlink traffic, to determine an absence of any downlink traffic for transmission to the second device. The SP termination notification may be transmitted according to the absence. In some embodiments, to determine the status of the downlink traffic, the one or more processors are configured to determine, by the first device, a presence of the downlink traffic for transmission to the second device.

In some embodiments, the one or more processors are configured to transmit, via the transceiver to the second device, the downlink traffic. The SP termination notification may be transmitted responsive to transmission of the downlink traffic. In some embodiments, the first device receives the indication as a defined value in a buffer status report (BSR) from the second device. In some embodiments, the defined value comprises a predetermined value of a queue size of the BSR. In some embodiments, the defined value comprises a predetermined combination of values, corresponding to an access category (ACI) bitmap field and a delta traffic identifier (TID) field.

In another aspect, this disclosure is directed to a method. The method may include transmitting, by a first device to a second device, an indication for terminating a target wake time (TWT) service period (SP). The method may include receiving, by the first device from the second device, an SP termination notification, according to the indication. The method may include terminating, by the first device, the TWT SP according to the SP termination notification.

In some embodiments, the method includes receiving, by the first device from the second device, downlink traffic after transmitting the indication to the second device. The first device may receive the SP termination notification after the downlink traffic is received from the second device. In some embodiments, the first device transmits the indication as a defined value in a buffer status report (BSR) from the second device. In some embodiments, the defined value comprises at least one of a predetermined value of a queue size of the BSR, or a predetermined combination of values, corresponding to an access category (ACI) bitmap field and a delta traffic identifier (TID) field.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a block diagram of a computing environment, according to an example implementation of the present disclosure.

FIG. 6 is a flowchart showing an example method of service period termination, according to an example implementation of the present disclosure.

FIG. 7 is a block diagram of a computing environment, according to an example implementation of the present disclosure.

FIG. 8 is a diagram showing an example frame structure of a buffer status report (BSR), according to an example implementation of the present disclosure.

FIG. 9 is a timing diagram showing service period events, according to an example implementation of the present disclosure.

FIG. 10 is a flowchart showing an example method of service period termination, according to an example implementation of the present disclosure.

FIG. 11 is a flowchart showing an example method of service period termination, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz. An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

Energy saving may be desirable in many devices due to environmental, battery life, or thermal concerns, including various devices of an AR/VR context. Such devices can include STAs, and APs, including a mobile AP (“hotspot”), Wi-Fi direct group owner (GO), or a device configured to alternatively operate as an AP and an STA. For example, the operating time of a head mounted device (HMD) can be limited by a battery life or thermal constraint, such that the HMD can opportunistically enter a sleep state (at least for a transceiver) to reduce energy usage and thermal loads. However, network latency along with sleep states can prove challenging. Latency sensitive traffic that is not prioritized (or protected) may degrade a user experience. For example, in an AR context, latency between a movement of a user wearing an AR device and an image corresponding to the user movement and displayed to the user using the AR device may cause judder, resulting in motion sickness.

A Target Wake Time (TWT) is a mechanism where a set of service periods (SPs) are defined and shared between devices to reduce medium contention and improve the power efficiency of network devices. The TWT reduces energy consumption of the devices by limiting the awake time and associated power consumption of the devices. For example, the first device can wake up periodically (e.g., at a fixed, configured time interval/period/cycle) based on the TWT. The periodicity of the SP can be configured for the communication of latency sensitive data. However, during at least a portion of an SP, little or no data may actually be available for transmission. That is, the total active time of an SP time can be overprovisioned relative to available traffic. Thus, although a substantial portion of the SP may not be used to transmit data, devices nonetheless maintain their transceivers in an active state because data may be sent during this time. Such idle active state time decreases energy and temporal efficiency. Early termination of the SP can mitigate such energy use, but may negatively impact network latency, in some embodiments.

The TWT can be agreed/negotiated upon by devices (e.g., access points (APs) and/or stations (STAs)), or specified/configured by one device (e.g., an AP). During the SP, a first device (e.g., a STA) may be in an awake state (e.g., its wireless communication module/interface is in a fully powered-up, ready, or wake state) and is able to transmit and/or receive. When the first device is not awake (e.g., its wireless communication module/interface is in a powered-down, low power, or sleep state), the first device may enter a low power mode or other sleep mode (sometimes referred to as a DOZE mode), which may reduce a power use or a thermal load of the first device. The first device may remain in the sleep mode until a time instance/window as specified by the TWT.

In addition to or instead of the sleep state, a device can communicate with other devices. For example, a STA or AP device can communicate with devices of a same or different network as an AP or non-AP device during periods of unavailability. For example, upon an early termination or other cessation of a SP, various devices can connect to other networks or devices, such as an AP servicing further STA with a different SP (e.g., a non-overlapping SP). Such scheduling can avoid contention and reduce latency, such as latency of virtual objects included in video frames transmitted from a computing device to a head mounted device (HMD). Further, such scheduling can prove helpful for devices configured to operate multiple STA groupings (of one or more basic service sets (BSS)), or for devices configured to operate alternatively as an AP and STA. For example, an HMD can operate as an AP with respect to various peripheral devices, and as an STA with respect to another AP (e.g., a router).

Some standards may define target wake time (TWT) service period (SP) early termination. For example, an AP may indicate an end of service period EOSP=1 and more data=0 in specific frames of a packet (or packets) sent to a station (STA). A TWT scheduled station (STA) may remain awake from the start of the SP until either the end of the SP or the AP indicates SP termination. If the STA has already delivered and received traffic intended for the SP, the STA may enter a sleep mode after early SP termination to save power. In some instances, an AP may terminate the SP earlier than the STA is expecting, and the STA may still have additional traffic to deliver to the AP. In such instances, the STA may switch to a sleep mode without delivering its traffic, or may lose out of AP scheduling and prioritization benefits of the TWT SP. As such, because there is no way in which an STA can indicate its readiness to terminate the SP or request to do so, the AP may not wait for any such indication and terminate the SP anytime the AP determines to do so.

Prior to transmitting an EOSP, the AP can determine that no downlink traffic is present, or that all downlink traffic has already been transmitted, and provide the EOSP to any relevant STA devices, responsive to such a determination. The STA devices can, responsive to the receipt of the termination of the SP, enter a sleep state which may reduce a power usage thereof. The AP can also enter the sleep state upon terminating a service period for associated STAs.

However, if a STA has uplink data to transmit, the closure (e.g., ending, completion or termination) of the SP contraindicates such transmission. Even if the STA sent the uplink data following the EOSP, the AP device may not receive the uplink data, since the AP may be in a sleep state or otherwise be unavailable to the STA upon termination of the SP. Such issues can cause delays in providing a virtual object to a user through an HMD at a scheduled frame time, which can lead to the judder discussed above. Thus, the termination of the SP can defer uplink communications which can increase latency while TWT is engaged. Conversely, an AP configuration can disable early termination operation to maintain latency, but may lead to increased energy usage of various devices which can, for example, reduce the battery run-time of the HMD.

According to the present disclosure, a non-AP (e.g., STA) device can provide an indication of a readiness or intention to terminate an on-going SP. For example, the STA can provide a confirmation of, or precursor to, the EOSP provided to the STA by the AP. For example, the STA device can indicate an End Of uplink Traffic for the Service Period (EOT-SP). In a network including multiple STAs, the AP can provide a EOSP based on any number of EOT-SP. For example, the AP can terminate the SP for a subset of STA providing an EOT-SP, an individual STA, or defer an EOSP until receiving an EOT-SP for all STA associated with an SP.

Non-AP to AP communications may conform to a set of predefined communications frames or other data units to convey information elements. For example, a frame provided outside of a predefined set may not be received appropriately (e.g., may be interpreted as a data payload frame, and be passed to an application which is not configured to adjust SP times or transceiver states), or may not be handled appropriately by legacy devices or devices implementing proprietary encoding. Thus, the STA-provided EOT-SP can be provided as a part of an existing set of predefined information elements. According to the systems and methods described herein, an STA may indicate an end of traffic for SP (EOT-SP) to an AP. The STA may indicate the EOT-SP via a buffer status report (BSR) (e.g., by setting a particular value for an ACI bitmap and delta TID) and/or via a fixed value queue size in the BSR. The AP may determine, upon receiving the indication from the STA, whether any traffic is to be sent via a downlink to the STA. The AP may send any traffic as needed, and send a SP termination notification to the STA.

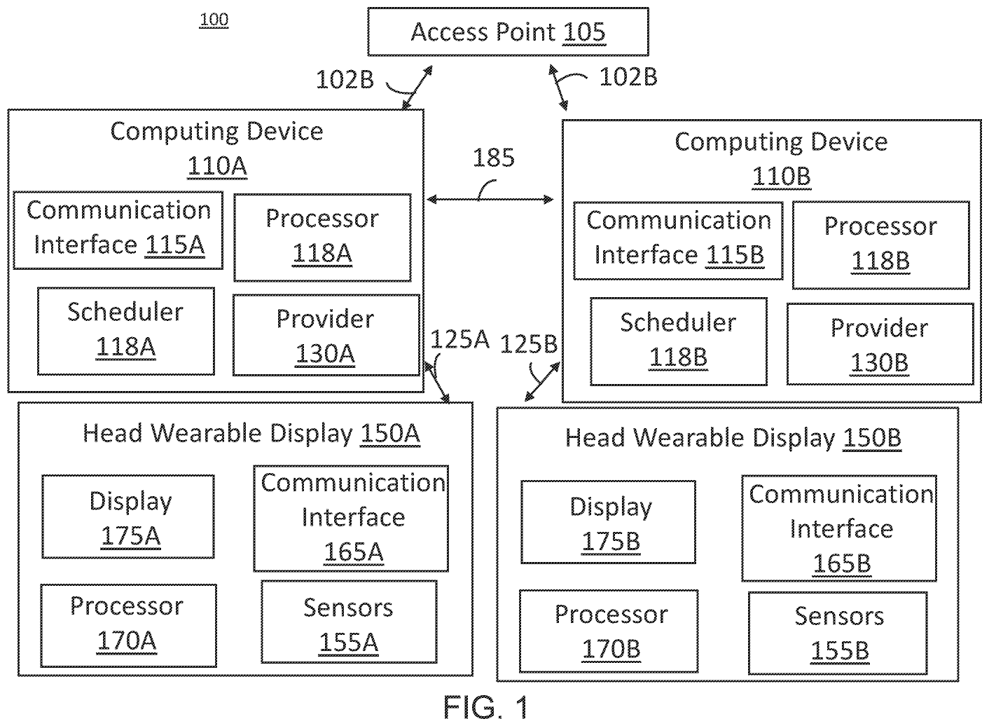

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request rTWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

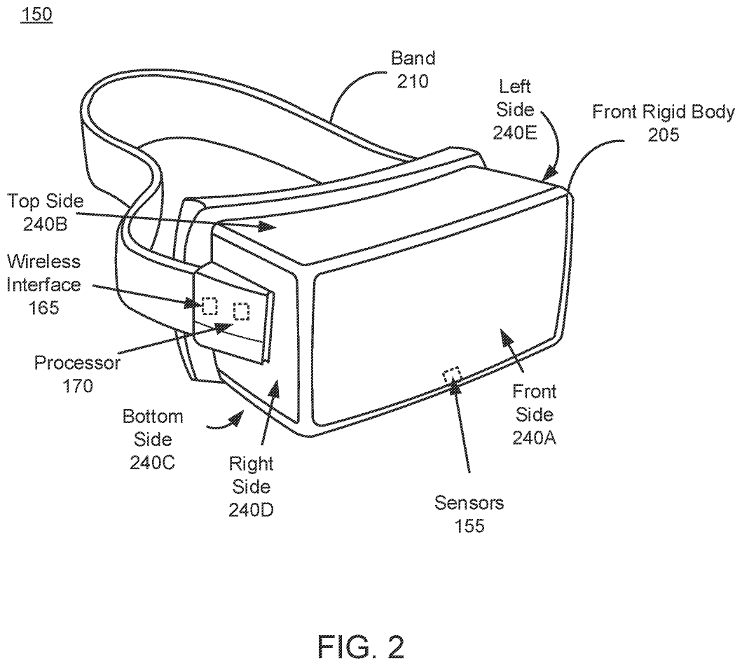

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

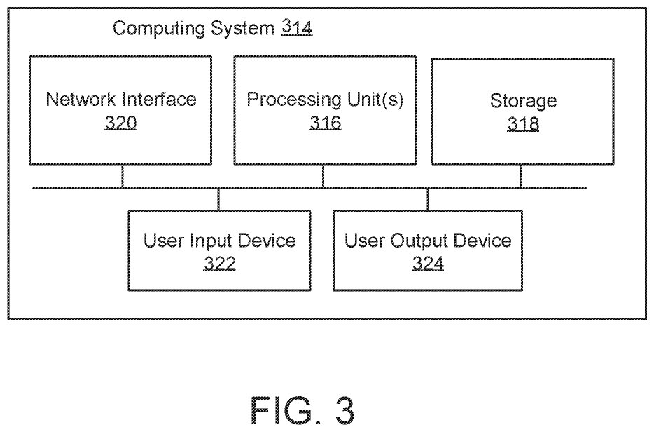

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHZ, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

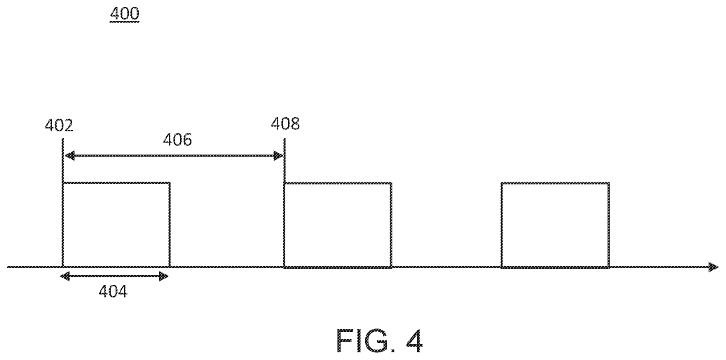

FIGS. 1-2 illustrate devices that communicate traffic streams, some of which may be latency sensitive (e.g., those carrying periodic AR/VR information/content). As described herein, the periodic operation of TWT benefits communication of periodic traffic (e.g., latency sensitive traffic) by predictably communicating the periodic traffic. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406. The communication and/or negotiation of the duration 404 between devices can lower energy use (e.g., wherein a device can enter a sleep state between durations 404), and improve latency/network congestion (e.g., by deferring a communication until a duration 404 when another device is expected to be awake, repeated communications and associated delays can be obviated).

A TWT schedule may be communicated and/or negotiated using broadcast TWT (bTWT) and/or individual TWT (iTWT) signaling. In some embodiments, to signal iTWT, TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or rTWT) in P2P communication. Accordingly, a P2P model where a P2P STA (e.g., a HWD 150) is not associated with an infra-basic service set (BSS) AP, may improve communication. Without AP's assistance or coordination, a transmission over the P2P link may collide with another transmission in the BSS. In some embodiments, a reverse direction protocol (RDP) may be enabled for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

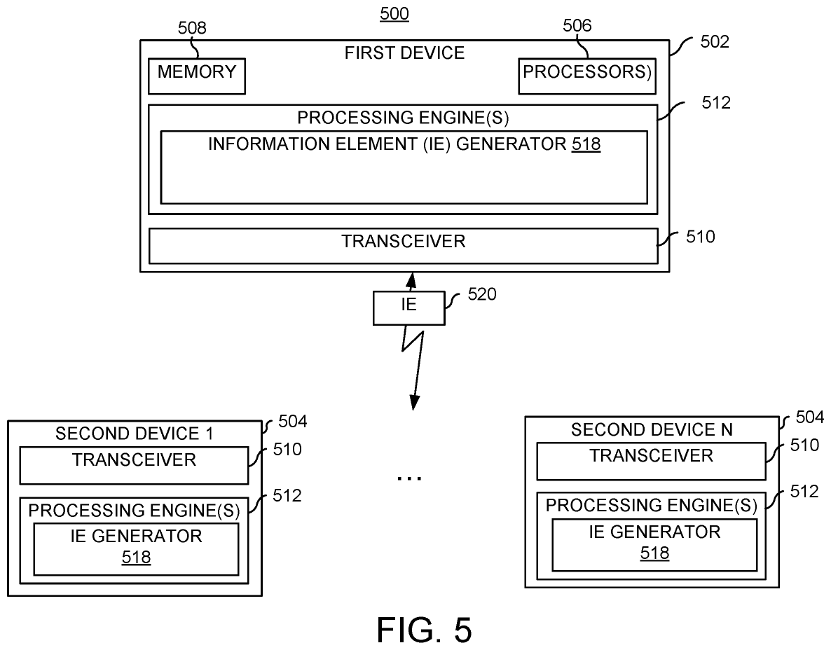

Referring now to FIG. 5, depicted is a block diagram of computing environment 500, according to an example implementation of the present disclosure. The computing environment can include a system for TWT-SP termination. The system may include a first device 502 and any number second devices 504 (referred to generally as a second device 504). The first device 502 may be or include an AP 105 (e.g., soft AP 105) a Wi-Fi direct GO, or the like. The first device 502 and one or more of the second devices 504 can be configured to operate in one or more modes of operations or in one or more networks. For example, a HWD 150 can be a second device 504 communicatively coupled with a first device 502 such as a Wi-Fi router, and a first device 502 communicatively coupled with a second device 504, such as a computing device 110, peripheral device, or another HWD 150 (e.g., a STA). The first device 502 (and second device 504) may include one or more processors 506 and memory 508, which may be similar, respectively, to the processor(s) 118/170 or processing units 316 and storage 318 described above with reference to FIG. 1-FIG. 3. The first device 502 and second device 504 may include respective transceivers 510 and processing engine(s) 512. The transceivers 510 may be similar to the communication interface(s) 115, 165 and the processing engine(s) 512 may be similar to the processing unit(s) 316, described above with reference to FIG. 1-FIG. 3.

As described in greater detail below, the first device 502 may be configured to generate/establish information elements (IE) 520 for transmission (in a message) to the second device(s) 504. The IE 520 may convey TWT parameters between the first device 502 and second device(s) 504, such as to establish a TWT, or adjust the TWT (e.g., an end of service period (EOSP), buffer status report poll (BSRP), or so forth). The first device 502 may be configured to transmit, send, communicate, or otherwise provide the IE 520 to the second device 504. The second device 504 may be configured to transmit, send, communicate, or otherwise provide further IE 520 to the first devices.

The first device 502 and second device 504 may support various TWT functionalities/tasks/functions for communication during a session between the devices 502, 504. The first device 502 may include an information element (IE) generator 518. The IE generator 518 may be or include any device, component, processor, circuitry, or hardware designed or configured to establish, produce, create, or otherwise generate an IE 520 for transmission to the second device 504. For example, the IE generator 518 of the first device 502 can generate an IE 520 to schedule a SP and thereafter, generate another IE 520 to terminate the scheduled SP. An IE generator 518 of the second device 504 can generate an IE 520 to provide an indication of a readiness to terminate the SP, such as in indication of an absence or End Of UL Traffic for the SP, an EOT-SP. The IE generators 518 may be configured to generate further IE 520 to configure or establish the session between the first device 502 and second device 504, or otherwise maintain a communicative connection between the various devices.

The first device 502 may be configured to communicate, transmit, send, or otherwise provide the IE 520 to the second device 504. In some embodiments, the first device 502 may be configured to provide the IE 520 to the second device 504 via the respective transceivers 510. In this regard, the first device 502 may be configured to provide the IE 520 in-band (e.g., as a Wi-Fi message) to the second device 504. The various IE 520 may be embedded into a frame, packet, or other message. For example, the IE 520 may be encoded according to a predefined bit sequence of a transmission. Thus, references, herein, to messages, frames, or other data (e.g., indications) exchanged between the first device 502 and second devices 504 may refer to the provision of a message including an IE 520.

The second device 504 may be configured to receive the IE 520 from the first device 502. Where multiple second devices 504 are in an environment (e.g., a BSS or subset thereof associated with a SP), each second device 504 or a single of the second devices may receive the IE 520 from the first device 502. The second device(s) 504 may be configured to receive the IE 520 via the transceiver 510. The second device 504 may be configured to respond to the IE 520 (e.g., to accept various configurations of the IE 520, to modify various configurations, etc.) as part of a handshake with the first device 502. For example, the second device 504 can respond to an IE 520 indicating a TWT SP termination, or otherwise send an IE 520 to the first device 502. The TWT SP termination may be or include an indication that the second device is requesting to terminate the SP. For example, the second device 504 may provide the indication, responsive to determining an absence of uplink traffic to send to the first device 502. As another example, the second device 504 may provide the indication, responsive to determining to terminate the SP for another reason, such as for power consumption, coexistence with another service period, etc. The second device may include the indication in an IE 520. The IE 520 may include an indication of a presence or absence of traffic (the EOT-SP). In other words, the indication may be or include an EOT-SP as described below. For example, the first device 502 can provide the second device 504 with an EOSP, and the second device 504 can provide the first device 502 with an EOT-SP. In some embodiments, the second device 504 can provide the first device 502 with an EOT-SP prior to the provision, by the second device 504 to the first device 502, of the EOSP. For example, the transmission of the EOSP can conclude the SP, where the first device 502 or second device 504 can enter a sleep state or otherwise cease monitoring of a medium upon the transmission (and receipt, respectively) of the EOSP.

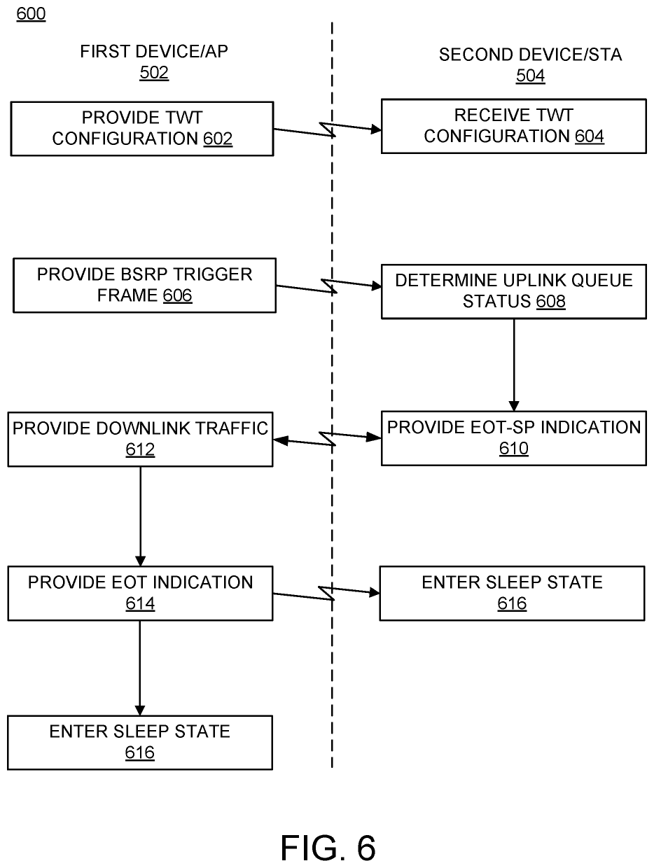

Referring now to FIG. 6, depicted is a flowchart showing an example method 600 for TWT termination, according to an example implementation of the present disclosure. The method 600 may be performed by various devices, components, or elements described above with reference to FIG. 1-FIG. 5. In some embodiments, some steps, operations, or processes of the method 600 may be performed by one device (such as the first device 502), and other steps or processes of the method 600 may be performed by another device (such as the second device 504). The method is described with reference to an illustrative example of an AP 105 and a STA device (e.g., as computing device 110), though it should be understood that that such an illustrative example is non-limiting. For example, the AP 105 can include a device operable as a STA device, and the STA can include a device operable as an AP 105 device. Likewise, the first device 502 can refer to a GO and the second device 504 can refer to a client of the GO within the present disclosure.

At operation 602, an AP 105 may generate one or more first IE 520 configured to define a TWT parameter. For example, the AP 105 can provide an indication in a broadcast frame such as a beacon frame to one or more STA devices, or an individual TWT to a particular STA. In some embodiments, the first IE 520 can be provided incident to negotiation between the AP 105 and one or more STA. For example, the AP 105 can assign the TWT parameters or the AP 105 and one or more STA can negotiate a TWT Wake Interval (e.g., time between successive TWT sessions), corresponding to the SP interval 406 of FIG. 4, TWT Wake Duration (e.g., how long the device stays awake), corresponding to the duration 404 of FIG. 4, and TWT Offset (e.g., the time offset for the start of the TWT session). The TWT Offset can be offset from a defined network time, such as to cause various devices to have non-overlapping Wake Durations.

At operation 604, the STA can receive one or more IE 520 indicative of the TWT configuration. For example, the STA can receive a first indication of a TWT session in a beacon frame from an AP 105 indicating that a BSS is a TWT enabled BSS. In some embodiments, the STA can receive a first or subsequent IE 520 indicative of a the TWT thereafter, such as subsequent to an association of the STA with the AP 105. For example, the IE 520 indicative of the TWT configuration can be received incident to the negotiation described above, with regard to operation 602.

At operation 606, the AP 105 can solicit/request, from the STA, a presence of uplink traffic from the STA. For example, the AP 105 can provide a buffer status report poll (BSRP) trigger or other trigger frame to the STA. Like other operations of the method 600, the provision of the BSRP can be omitted or modified, such as in embodiments wherein the STA provides an unsolicited indication of uplink traffic to the first device 502 (e.g., an unsolicited BSR). Indeed, various operations of the method 600 can be omitted, added, or substituted.

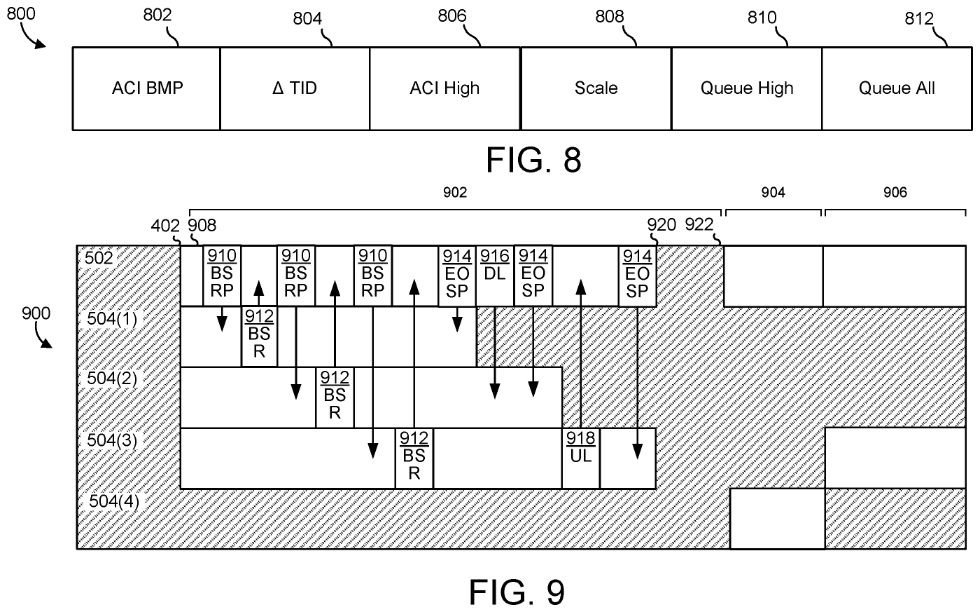

At operation 608, the STA determines a presence of uplink traffic. In some embodiments, the presence can include an indication of subdivisions of information, according to various access categories or other traffic identifiers. In some embodiments, the determination of the presence of uplink traffic may be responsive to a periodic or interrupt driven schedule local to the STA. In some embodiments, the determination of the presence of uplink traffic may be responsive to the receipt of the solicitation from the first device (e.g., the BSRP) at operation 606. The STA can encode the determination of the presence of uplink traffic into one or more IE 520 which are provided to the AP 105, such as via a buffer status report (BSR), as depicted hereinafter at FIG. 8.

At operation 610, the STA can provide an EOT-SP to the AP 105. The EOT-SP can include a binary indication that the STA does, or does not, have uplink traffic to provide to the AP 105 prior to the expiration of the SP. Various illustrative embodiments of the encoding of the determination are provided henceforth, with regard to the BSR depicted at FIG. 8. The EOT-SP can be provided at a predetermined time within an SP, responsive to the BSRP trigger frame of operation 606, or otherwise provided to the STA. In some embodiments, the EOT-SP is encoded into a BSR. In some embodiments, the STA can provide more than one EOT-SP. For example, a first EOT-SP can indicate a presence of UL traffic. Upon a provision of such traffic, the STA can provide a further EOT-SP indicating an absence of traffic. None, either, or both of the EOT-SP can be solicited by the AP, in some embodiments.

At operation 612, the AP 105 may provide Downlink traffic to the STA, or otherwise determine a completion of Downlink traffic. Downlink traffic can include various traffic types such as latency sensitive data, non-latency sensitive data, management frames, and so forth. The downlink traffic, along with any frame controls associated therewith (ACK or NACK frames), may be conveyed prior to the expiration of an SP. Upon provision of DL traffic, the AP 105 can determine a remaining portion of an SP. In some embodiments, the AP 105 may determine the completion of DL traffic based on an indication that no DL traffic exists. For example, the remaining period in the SP can be a complete SP.

At operation 614, the AP 105 may transmit the EOSP. In some embodiments, the AP 105 may transmit the EOSP responsive to a determination that one or more STA have provided an EOT-SP indicating a lack of UL traffic. For example, the AP 105 may transmit an EOSP to a particular STA upon receiving an EOT-SP from the particular STA, or may transmit a broadcast EOSP to a group of STA upon receiving an EOT-SP from every STA of the group. In some embodiments, the AP 105 can provide an EOSP to a group upon receiving an EOT-SP from a subset of one or more STA of the group. For example, the AP 105 can identity priority/latency sensitive devices and non-priority/latency insensitive devices, and can terminate a group SP upon receipt of an indication from all priority/latency sensitive devices.

In some embodiments, the AP 105 may omit/skip the EOSP. For example, the AP 105 can provide downlink traffic until a scheduled closure of the SP. In some embodiments, the AP 105 may compare a remaining portion of the duration of the SP to a threshold, and can provide or omit an EOSP based on the comparison to the threshold. For example, where a remaining portion of the SP is less than a time to provide an EOSP (along with any associated signaling, such as the transmission of the BSRP trigger or the receipt of the BSR or other EOT-SP), the AP 105 may omit the EOSP and await the scheduled closure of the SP. In some embodiments, the AP 105 can determine that an energy use (e.g., for the AP 105 or one or more STA devices) associated with closing the SP early may exceed an energy use of maintaining the SP until a scheduled closure. For example, the energy use for the transmission of the BSRP frame trigger or the EOSP at the AP 105 can exceed the energy use from monitoring the medium for the remainder of the SP, or the energy use for the transmission of the BSR or the EOT-SP at the AP 105 can exceed the energy use from monitoring the medium for the remainder of the SP. Responsive to such a determination the AP 105 may await the scheduled closure of the SP.

At operation 616, the AP 105 and/or STA may enter a enter a sleep state. For example, the sleep state can reduce transceiver power with respect to a wireless medium between the AP 105 and STA. In some embodiments, the AP 105 or STA may perform other operations during this time, such as communication with other devices over another wireless medium (e.g., another time-slice, frequency, logical organization (e.g., BSS), or so forth). The sleep state may apply to various components of the AP 105 or STA. For example, the sleep state may include a sleep state of a transceiver 510, processor engine 512, or other device portion.

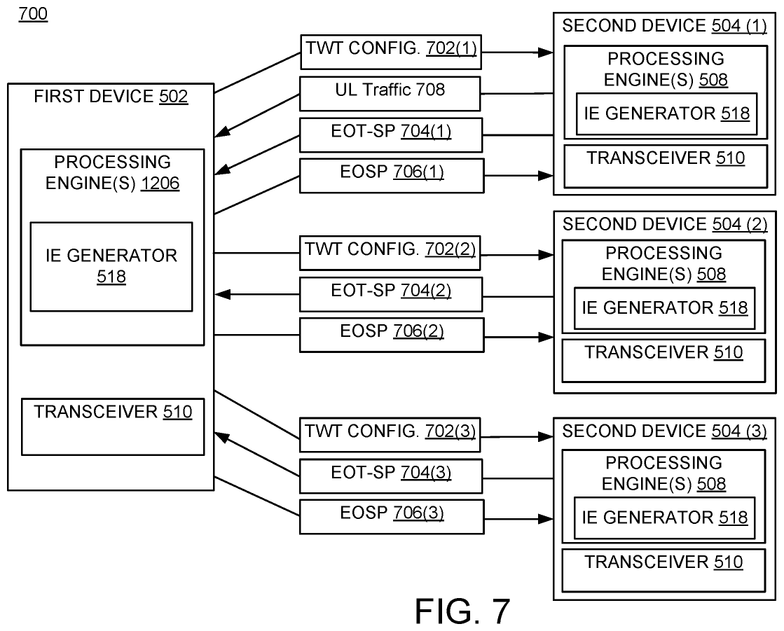

The depicted sequence is intended to be illustrative and non-limiting. For example, in some embodiments, the AP 105 can provide a BSRP trigger upon a completion of the provision of downlink traffic. Moreover, operations performed in sequence may be performed responsive to a prior operation, according to a predefined schedule, or otherwise (e.g., based on a local interrupt associated with an availability of uplink or downlink traffic). Some operations can be performed simultaneously with other operations. For example, the STA can determine the uplink queue status continuously or during other operations. The AP 105 can provide, adjust, or otherwise provide TWT configuration parameters (e.g., operation 602) between other operations, or upon a completion of the depicted method. Further, the method 600 may be performed with periodicity, and may vary in sequence from period to period (or from STA to STA). For example, in one instance, a STA can provide an unsolicited BSR frame. In another example, the AP 105 can provide the BSRP frame prior to the provision of the downlink traffic. In yet another example, the AP 105 can provide the BSRP frame subsequent to the provision of the downlink traffic, or concurrently with operation 606 (e.g., via interleaving, a side channel, or so forth). Indeed, according to various embodiments, networks including various devices, such as the devices depicted throughout the present disclosure (e.g., at FIG. 7), can employ various instances of the method 600 of FIG. 6 during a SP (and can further include other devices for other frequency or time-orthogonal devices having non-overlapping SPs).

Referring to FIG. 7, block diagram of a computing environment 700 is provided. The computing environment 700 includes a first device 502, and various second devices 504(1)-504(3). As with the method 600 of FIG. 6, the first device can include various AP 105 device types such as a soft AP 105 or other AP 105, or GO. The various second devices 504 can include non-AP such as STA, Wi-Fi-direct clients, and so forth (e.g., computing devices 110, peripheral devices, or so forth). As indicated above, any non-AP devices may operate with further devices still (or during different times or frequencies) as an AP 105, as an AP 105 device may operate as an STA (e.g., with respect to other devices or at other times as the depicted STA).

The first device can establish a same or overlapping TWT for any number of second devices 504. The first device 502 may establish further TWT with additional devices, or an individual TWT (iTWT) with any of the depicted second devices 504. The first device 502 can terminate a SP with respect to one or more second devices 504 according to the method 600 of FIG. 6. In some embodiments, the first device 502 may perform the various operations of FIG. 6 in a synchronous or asynchronous manner with respect to the various depicted second devices 504. For example, the first device 502 can generate broadcast frames for the various second devices 504 or can provide individual messages to each of the second devices 504 (e.g., sequence messages to the various second devices 504 according to a predefined order, or responsive to communication (e.g., EOT-SPs 704) received from the second devices 504). The BSRP of the method 600 of FIG. 6 is not depicted for clarity. The BSRP may be included or omitted according to various embodiments, or instances thereof (e.g., the second devices 504 can provide unsolicited BSR or otherwise solicited BSR).

The first device 502 may provide a TWT configuration message 702 to the various second devices 504. For example, the first device 502 can provide the TWT configuration message 702 incident to association with the various second devices 504, or via a subsequent negotiation including various responses (not depicted) from the second devices 504. The various TWT configuration messages 702 can be sent separately to the devices (e.g., upon their respective associations) or at a same time. One or more of the second devices 504 can determine that uplink traffic is available for transmission to the first device 502, and can send a message which omits an EOT-SP 704 to the first device 502 indicating the pendency of the uplink traffic. One or more of the second devices 504 can determine that uplink traffic is not present for transmission to the first device 502, and can send an EOT-SP message 704 to the first device 502 indicating the absence of the uplink traffic. In some embodiments, one or more of the second devices 504 can omit the EOT-SP message 704. For example, a legacy device which is not configured to provide an EOT-SP message 704 can omit the message, whereupon the first device 502 can determine that such a second device 504 may have uplink traffic. Based on such a determination, the first device 502 may omit an EOSP 706 to the legacy device.

In an illustrative example, one of the second devices, 504(1), may indicate a pendency of uplink traffic 708, and the other of the second devices 504(2, 3) can indicate an absence of uplink traffic (e.g., the EOT-SP 704(2, 3)). Responsive to the receipt of the EOT-SPs 704(2, 3), the first device 502 can provide an EOSP 706(2, 3) to the other of the second devices 504(2, 3), and await or initiate traffic from second device 504(1). Responsive to the receipt of the EOSP 706(2, 3), the other of the second devices 504(2, 3) can enter a low power mode or otherwise utilize a transceiver.

The second device 504(1) can provide the uplink traffic 708, which may be provided responsive to an initiation of the first device 502. Responsive to a completion of the uplink traffic 708, the second device 504(1) can provide an EOT-SP 704(1) to the first device. Such an EOT-SP 704(1) can be provided unsolicited (e.g., upon a completion of the UL traffic 708 to the first device 502 or upon receipt of an acknowledgement (ACK) of transmission received at the second device 504(1) from the first device 502), or solicited, the solicitation (e.g., from the first device 502) being responsive to, for example, a BSRP frame generated by the first device 502, responsive to the completion of the receipt of the uplink traffic 708.

Responsive to the receipt of the EOT-SP 704(1), the first device can provide an EOSP 706(1) to the second device 504(1), terminating the SP. Upon such termination, the first device 502 and the second device 504(1) can enter a sleep state, operate on another network, or otherwise defer monitoring a medium therebetween until a subsequent SP instance.

Referring to FIG. 8, a diagram showing an example frame structure of a buffer status report (BSR) 800 is provided. The EOT-SP can be conveyed as a defined value or combination of values in the BSR 800, in some embodiments. For example, the EOT-SP can be provided as a binary indication according to an encoding of various bits of the BSR 800. A brief summary of the various information elements 520 of the BSR 800 is provided below, to aid in the understanding of the specific encodings provided hereinafter.

The BSR 800 can include an access category identifier (ACI) bitmap 802, which may provide an indication of a traffic type. For example, a separate bit may map to each of voice traffic (AC_VO), video traffic (AC_VI), best effort traffic (AC_BE), or background traffic (AC_BK). That is, the ACI bitmap 802 may be a four-bit IE 520 corresponding to each of the traffic types. The ACI bitmap 802 can indicate a presence of zero or more traffic types of a pending category. For example, where only the video traffic is queued, a register value of “0100” can indicate a presence of the video data and the absence of voice, best effort, and background traffic. In another example, register value of “1100” can indicate a presence of voice and video traffic.

Each ACI of the ACI bitmap 802 can correspond to one or more Traffic Identifiers (TID), which may define the traffic according to a more granular approach (e.g., a subcategory). For example, voice can be subdivided into real-time voice and standard voice traffic. The BSR 800 can include a field to depict a Traffic Identifier (TID), indicating a presence of a TID for the one or more ACI bits. That is, the TID may be mapped to an ACI on an n to 1 basis, as indicated by the A TID field 804, where the A TID field 804 indicates which of the one or more TIDs indicate a change in the current provision of the BSR 800 (but may not indicate an association with a particular ACI). Some TID bits are reserved for certain ACI, according to an ACI bitmap 802 status. For example, when all bits of an ACI bitmap 802 are empty (set to zero “0000”), a & TID field 804 value of 3 (“11”) can indicate a presence of traffic on all TID (e.g., 8 TIDs). Other values, such as 0, 1, and 2 are not defined for the case of an empty ACI bitmap 802.

The ACI high field 806 may indicate an ACI of highest priority or relevance. For example, for a four-bit ACI bitmap 802, a 2-bit ACI high field 806 can depict which of the four bits is a highest priority or relevancy to the current traffic. The Queue Size High field 810 indicates a queue size associated with the ACI indicated by the ACI high field 806. For example, where a queue size for an ACI (e.g., a TID thereof) indicated by the ACI High field 806 is 256 units, the queue size can indicate 256. The units may be provided according to the scaling factor 808. The scaling factor 808 can correspond to a size of a queue according to a byte-scale, word scale, double word scale, or other scale. The scaling factor 808 also corresponds to the Queue Size All field 812.

The Queue Size All 812 indicates a queue size of all buffers, including the Queue Size High buffer 810. Thus, the Queue Size All 812 will/can be at least as large as the Queue Size High field 810 when both IE 520 are employed for their named purpose. For example, if a separate 256-unit buffer is provided for traffic of each of 8 TIDs, and the buffers are uniformly sized, a Queue Size All can indicate a size of 2048 units, the units being defined according to the scaling field 808.

As indicated above, the EOT-SP can be encoded in various fields of frames (also be referred to as IE 520) exchanged between network connected devices. For example, as further indicated above, the frames exchanged between network connected devices can include BSR 800 frames. Such encodings can be configured to avoid overlapping with other reporting conditions to prevent ambiguity. For example, if the ACI bitmap 802 indicates that no traffic corresponding to any of the ACI is present (e.g., a bit value of “0000” for a four-bit value, the empty bitmap, along with other field values may be used to encode an EOT-SP value (e.g., a digital indication of a presence or absence of uplink traffic). For example, where the ACI bitmap is empty, the EOT-SP can be encoded according to a value of the A TID field. (e.g., “00” corresponding to a logical zero of the EOT-SP, and a “01” corresponding to a logical zero of the EOT-SP).

In another example, the EOT-SP can be encoded according to a queue size. For example, mapped to a predetermined value of a queue size. The queue size may be selected according to a size which is not expected to be encountered in normal use. For example, the predetermined queue size may be an irregular queue size (e.g., non-power of two size, or a queue size which is larger or smaller than are in typical use). The predetermined queue size can be a minimum or maximum value of encodable in the BSR 800 according to the Queue Size High 810, Queue Size All 812, scaling value 808, or combination thereof. In some embodiments, the predefined queue size can be selected to correspond to a unit of BSR 800 control (e.g., 16 octets (bytes)). In some embodiments, the predefined queue size can be selected to correspond to a Queue Size subfield of a QoS Control IE 520 (e.g., 256 octets). The Queue size indication can be provided according to one of the Queue Size High 810 or Queue Size All fields 812. The other of the Queue Size High 810 or Queue Size All fields 812 can be set to zero, or to a same value, or to another value which may represent an invalid expression of queue sizes, in some embodiments. Such an element can map to either of a logical ‘1’ or ‘0’ such that one encoding can depict a presence of uplink traffic and another encoding can depict an absence of uplink traffic.

Referring to FIG. 9, a timeline 900 of network activity is depicted. The timeline corresponds to a network including a first device 502 and second devices 504, which may include the second devices 504(1-3) of the computing environment 700 of FIG. 7, sharing a first SP 902. A further second device 504(4) can communicate with the first device 502 during a second SP 904 which does not overlap with the first SP 902. Some devices can include multiple SPs, as is depicted with one of the second devices 504(3) having a third SP 906. The timeline 900, like the other figures provided herein is not intended to be drawn to scale. Indeed, various aspects of the timeline 900 are drawn to emphasize features and improve legibility. For example, the various SP can be of a same or different length as each other. Moreover, although a particular sequence is provided, such a sequence is intended to be illustrative, and non-limiting. The sequence or other aspects of the timeline 900 can be modified according to the various aspects of the present disclosure.

At a TWT start time 402, the various devices associated with the first SP 902 can monitor a wireless communications medium between the first device 502 and the second devices 504. At a time 908 subsequent to the TWT start time 402, the first device 502 can provide a BSRP trigger frame 910 (or other solicitation) to the second devices 504(1, 2, 3). The second devices 504 can respond with a BSR 912, the BSR 912 including an EOT-SP according to a presence or absence of uplink data for provision to the first device 502. That is, the BSR 912 can include a binary indication of a presence or absence of uplink traffic. The first device 502 can determine a presence of downlink traffic for each of the second devices 504(1-3).

The first device 502 can determine that no downlink traffic exists for one of the second devices 504(1), and (according to the EOT-SP) that the second device 504(1) lacks UL traffic for the first device 502. Based on the determination that neither UL not DL traffic exist corresponding to the second device 504(1), the first device 502 can provide an EOSP 914 thereto.

The first device 502 can determine that DL traffic 916 exists for one of the second devices 504(2), and (according to the EOT-SP) that the second device 504(2) lacks uplink traffic for the first device 502. Based on the determination, the first device 502 can provide the DL traffic 916 to the second device 504(2). The DL traffic 916 or other data conveyances provided herein may include any number of messages, payload sizes, or associated control signaling. Where the DL traffic 916 is provided prior to an end of the SP 902, the first device 502 can determine, based on the completion of the DL traffic 916, that no remaining UL or DL traffic exists for the second device 504(2). Responsive to such a determination, the first device 502 can provide an EOSP 914 thereto.

The first device 502 can determine that DL traffic 918 does not exist for one of the second devices 504(3), and (according to the EOT-SP) that the second device 504(3) has uplink traffic for the first device 502. Based on the determination, the second device 504(3) can provide the UL traffic 918 to the first device 502 (e.g., according to an instruction of the first device 502). Where the UL traffic 918 is provided prior to an end of the SP 902, the first device 502 can determine, based on the completion of the UL traffic 916, that no remaining UL or DL traffic exists for the second device 504(3). Responsive to such a determination, the first device 502 can provide an EOSP 914 thereto. Upon provision of the EOSP 914, the first device 502 can determine that the SP 902 has been terminated for all other devices corresponding to the SP 902. Based on such a determination, the first device 502 can enter a sleep mode until a subsequent scheduled TWT, or perform another action, such as rescheduling further SP based on the early termination of the first SP 902 (e.g., adjust a future instance of the first SP 902, or other SPs). For example, the first device 502 can enter a sleep state at a time 920 which is prior to a scheduled closure time 922 of the first SP 902.

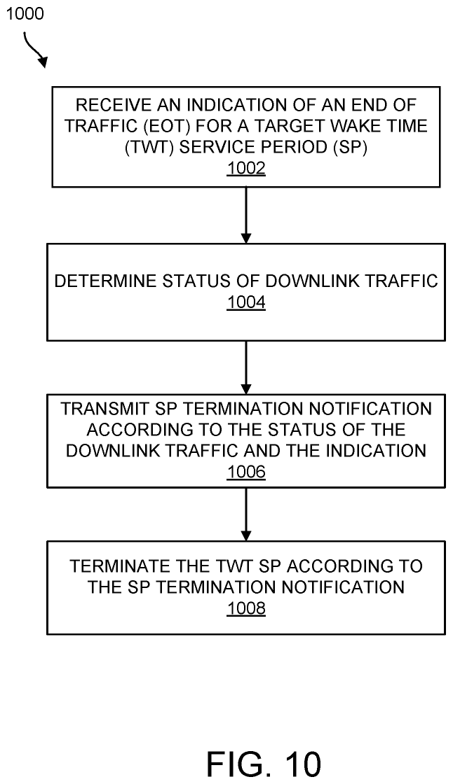

Referring now to FIG. 10, depicted is a flowchart showing an example method 1000 for service period termination, according to an example implementation of the present disclosure. The method 1000 may be performed by various devices, components, or elements described above with reference to FIG. 1-FIG. 9. For example, all or some steps, operations, or processes of the method 1000 may be performed by a first device 502 such as an AP 105. In some embodiments, steps, operations, or processes of the method 1000 may be performed by or in conjunction with another device such as a second device 504.

At operation 1002, the first device 502 may receive an indication of an end of traffic from a second device. The indication can correspond to an TWT SP. For example, the indication can be provided during the pendency of the SP. The indication can include an EOT-SP, which may provide a binary indication of a presence or absence of traffic from the second device 504. The EOT-SP can be received as a defined value in a BSR 800 from the second device 504. In some embodiments, the defined value can include a predetermined value of a queue size of the BSR 800 (e.g., Queue Size High 810 or Queue All Size 812). In some embodiments, the defined value can include a predetermined combination of values, corresponding to an access category (ACI) bitmap field and a delta traffic identifier (TID) field.

At operation 1004, the first device 502 may determine a status of downlink traffic for transmission to the second device 504. For example, the determination of the status can include determining a presence or absence of the downlink traffic. The first device 502 may determine the status of downlink traffic based on or according to a status of a buffer of the first device 502. For example, where the buffer includes traffic to be sent (e.g., outbound/downlink) to the second device, the first device 502 may determine a presence of downlink traffic. Similarly, where the buffer does not include any traffic to be sent outbound to the second device, the first device 502 may determine an absence of downlink traffic.

At operation 1006, the first device 502 may transmit an SP termination notification (e.g., the EOSP) to the second device 504. The SP termination notification can be provided according to the status of the downlink traffic and the indication received from the second device 504. For example, where uplink traffic or downlink traffic is not present, the first device 502 can provide the SP termination notification. Where UL traffic or DL traffic is present, the first device 502 may not provide such an SP termination notification (e.g., until such time as the UL traffic or DL traffic has been conveyed).

At operation 1008, the first device 502 can terminate the SP according to the SP termination notification. For example, the first device 502 can enter a sleep state, monitor another wireless medium which is not communicatively coupled with the second device 504, or otherwise severing (e.g., until a subsequent SP) a communicative connection between the first device 502 and the second device 504. In some embodiments, the termination may be effected by the transmission of the SP termination notification itself (e.g., where the second devices 504 are configured not to transmit frames to the first device 502 upon a receipt of the SP termination notification).

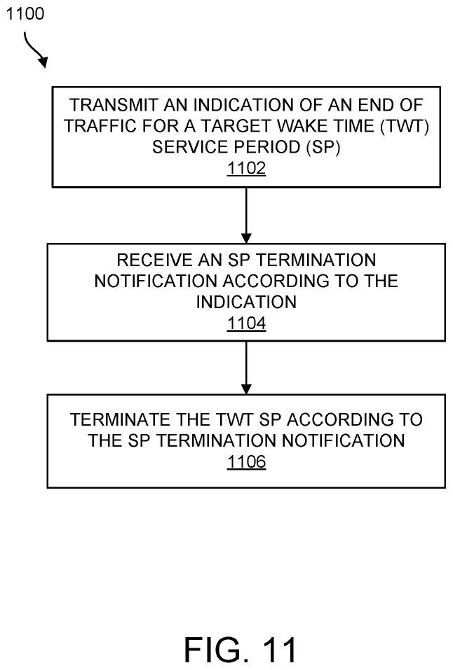

Referring now to FIG. 11, depicted is a flowchart showing an example method 1100 for service period termination, according to an example implementation of the present disclosure. The method 1100 may be performed by various devices, components, or elements described above with reference to FIG. 1-FIG. 10. For example, all or some steps, operations, or processes of the method 1100 may be performed by a first device such as a STA (e.g., the first device of the method 1100 can include the second device 504 of FIG. 5). In some embodiments, steps, operations, or processes of the method 1100 may be performed by another Wi-Fi direct client or other non-AP device, or in conjunction with an AP device. In some embodiments, the first device 502 of the method of FIG. 10 can be the second device of the present method 1100, and the respective methods 1000, 1100 can be performed simultaneously.

At operation 1102, the first device can transmit, to a second device, an indication of an end of traffic for a target wake time (TWT) service period (SP). The indication can be provided as an EOT-SP which includes a predefined value of a BSR 800. The indication can be provided unsolicited or responsive to a solicitation from an AP 105 device (e.g., a BSRP). The first device may transmit the indication to the second device, responsive to determining that no uplink traffic is to be sent to the second device. For example, similar to step 1004 of FIG. 10, the first device may determine a presence or absence of uplink traffic. The first device may determine the presence or absence of uplink traffic, based on or according to a status of a buffer of the first device. For example, where the buffer includes traffic to be sent (e.g., outbound/uplink) to the second device, the first device may determine a presence of uplink traffic. Similarly, where the buffer does not include any (e.g., remaining or additional) traffic to be sent outbound to the second device, the first device may determine an absence of uplink traffic.

At operation 1104, the first device receives an SP termination notification. For example, the SP termination notification can be received from an AP 105 device according to the indication. The SP termination notification may be received immediately following the provision of the indication of the end of traffic, or can be separated by other traffic, such as a receipt of downlink traffic from the AP 105 device or a provision of UL traffic to the SP device.

At operation 1106, the first device can terminate the TWT SP according to the SP termination notification. The termination, by the first device may not terminate the SP for other network connected devices. For example, the first device can place a transceiver into an idle or standby state, place a processor into a sleep state, or operate on another network which further devices continue to employ the SP to communicate data.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
receiving, by a first device from a second device, an indication for terminating a target wake time (TWT) service period (SP);
determining, by the first device, a status of downlink traffic for transmission to the second device;
transmitting, by the first device to the second device, an SP termination notification according to the status of the downlink traffic and the indication; and
terminating, by the first device, the TWT SP according to the SP termination notification.

2. The method of claim 1, wherein the first device comprises an access point and the second device comprises a station.

3. The method of claim 1, wherein determining the status of the downlink traffic comprises:
determining, by the first device, an absence of remaining or additional downlink traffic for transmission to the second device,
wherein the SP termination notification is transmitted according to the absence.

4. The method of claim 1, wherein determining the status of the downlink traffic comprises:
determining, by the first device, a presence of remaining or additional downlink traffic for transmission to the second device.

5. The method of claim 4, further comprising:
transmitting, by the first device to the second device, the downlink traffic,
wherein the SP termination notification is transmitted responsive to transmission of the downlink traffic.

6. The method of claim 1, wherein the first device receives the indication as a defined value in a buffer status report (BSR) from the second device.

7. The method of claim 6, wherein the defined value comprises a predetermined value of a queue size of the BSR.

8. The method of claim 6, wherein the defined value comprises a predetermined combination of values, corresponding to an access category (ACI) bitmap field and a delta traffic identifier (TID) field.

9. A first device, comprising:
a transceiver; and
one or more processors configured to:
receive, via a transceiver from a second device, an indication for terminating a target wake time (TWT) service period (SP);
determine a status of downlink traffic for transmission to the second device;
transmit, to the second device, an SP termination notification according to the status of the downlink traffic and the indication; and
terminate the TWT SP according to the SP termination notification.

10. The first device of claim 9, wherein the first device comprises an access point and the second device comprises a station.

11. The first device of claim 9, wherein, to determine the status of the downlink traffic, the one or more processors are configured to:
determine an absence of remaining or additional downlink traffic for transmission to the second device,
wherein the SP termination notification is transmitted according to the absence.

12. The first device of claim 9, wherein, to determine the status of the downlink traffic, the one or more processors are configured to:
determine, by the first device, a presence of remaining or additional downlink traffic for transmission to the second device.

13. The first device of claim 12, wherein the one or more processors are configured to:
transmit, via the transceiver to the second device, the downlink traffic,
wherein the SP termination notification is transmitted responsive to transmission of the downlink traffic.

14. The first device of claim 9, wherein the first device receives the indication as a defined value in a buffer status report (BSR) from the second device.

15. The first device of claim 14, wherein the defined value comprises a predetermined value of a queue size of the BSR.

16. The first device of claim 14, wherein the defined value comprises a predetermined combination of values, corresponding to an access category (ACI) bitmap field and a delta traffic identifier (TID) field.

17. A method comprising:
transmitting, by a first device to a second device, an indication for terminating a target wake time (TWT) service period (SP);
receiving, by the first device from the second device, an SP termination notification, according to the indication; and
terminating, by the first device, the TWT SP according to the SP termination notification.

18. The method of claim 17, further comprising:
receiving, by the first device from the second device, downlink traffic after transmitting the indication to the second device,
wherein the first device receives the SP termination notification after the downlink traffic is received from the second device.

19. The method of claim 17, wherein the first device transmits the indication as a defined value in a buffer status report (BSR) from the second device.

20. The method of claim 17, wherein the defined value comprises at least one of:
a predetermined value of a queue size of the BSR; or
a predetermined combination of values, corresponding to an access category (ACI) bitmap field and a delta traffic identifier (TID) field.
